(19) United States
(12) Patent Application Publication
(10) Pub. No.: US 2025/0157157 A1
(43) Pub. Date: May 15, 2025

(54) VIDEO SEE THROUGH REPROJECTION WITH GENERATIVE IMAGE CONTENT

(71) Applicant: Google LLC, Mountain View, CA (US)

(72) Inventors: Raymond Kirk Price, Carnation, WA (US); Dongeek Shin, San Jose, CA (US)

(21) Appl. No.: 18/942,058

(22) Filed: Nov. 8, 2024

Related U.S. Application Data
(60) Provisional application No. 63/597,600, filed on Nov. 9, 2023.

(51) Int. Cl. G06T 19/00

(52) U.S. Cl. CPC G06T 19/006; G06T 2210/62

(57) ABSTRACT

A computing device may receive image sensor data from a camera system on the computing device, transmit input data to an image generation model, where the input data includes the image sensor data, receive generative image content from the image generation model, and generate display content by combining the image sensor data and the generative image content.

### CROSS-REFERENCE TO RELATED APPLICATION

This application claims priority to U.S. Provisional Patent Application No. 63/597,600, filed on Nov. 9, 2023, entitled “VIDEO SEE THROUGH REPROJECTION WITH GENERATIVE AI IMAGE CONTENT”, the disclosure of which is incorporated by reference herein in its entirety.

### BACKGROUND

Video see through (VST) or passthrough reprojection on an extended reality (XR) device captures image sensor data from the real-world and reprojects the image sensor data on a display, where virtual objects can be overlaid on the image sensor data. There is an inverse relationship for VST cameras between angular resolution (e.g., pixels per degree) and field of view. In some examples, a system designer may use a wider field of view on the VST cameras to provide an immersive experience for the user. However, a wider field of view may result in lower angular resolution.

### SUMMARY

This disclosure relates to a technical solution of generating display content by combining image sensor data (e.g., pass-through video) from a camera system on an extended reality device with generative image content generated by an image generation model, which can provide one or more technical benefits of increasing the amount of high resolution display content by adding generative image content to the scene. The camera system may be a video see through (or video pass through) camera that captures a live video feed of the real world, which is then displayed on the device's display(s). The camera system may have a field of view (e.g., angular range of the scene) that is less than a field of view (e.g., angular range of the XR environment) of a display of the device. However, the device uses the generative image content to fill-in display content that is between the camera's field of view and the device's field of view. In this manner, the camera system can obtain image sensor data with a high angular resolution (e.g., pixels per degree) and uses the generative image content for outer visual content to provide a more immersive experience.

In some aspects, the techniques described herein relate to a computing device including: at least one processor; and a non-transitory computer readable medium storing executable instructions that cause the at least one processor to execute operations, the operations including: receiving image sensor data from a camera system on a computing device; transmitting input data to an image generation model, the input data including the image sensor data; receiving generative image content from the image generation model; and generating display content by combining the image sensor data and the generative image content.

In some aspects, the techniques described herein relate to a method including: receiving image sensor data from a camera system on a computing device; transmitting input data to an image generation model, the input data including the image sensor data; receiving generative image content from the image generation model; and generating display content by combining the image sensor data and the generative image content.

In some aspects, the techniques described herein relate to a non-transitory computer-readable medium storing executable instructions that cause at least one processor to execute operations, the operations including: receiving image sensor data from a camera system on a computing device; transmitting input data to an image generation model, the input data including the image sensor data; receiving generative image content from the image generation model; and generating display content by combining the image sensor data and the generative image content.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a transformation of image sensor data with a more limited field of view to an expanded field of view with a combination of the image sensor data and generative image content according to an aspect.

FIG. 1B illustrates an extended reality (XR) device that generates display content by combining image sensor data with generative image content from an image generation model according to an aspect.

FIG. 1C illustrates an example of generating image content and/or display content using input data according to an aspect.

FIG. 1D illustrates an example of generating an updated three-dimensional map and/or updated virtual content using a generative model according to an aspect.

FIG. 1E illustrates an example of communicating with an image generation model executing on a server computer according to an aspect.

FIG. 1F illustrates an image modification engine of the computing device according to an aspect.

FIG. 2 illustrates a flowchart depicting example operations of a computing device according to an aspect.

### DETAILED DESCRIPTION

This disclosure relates to a computing device that generates display content by combining image sensor data (e.g., pass-through video) from a camera system (e.g., a visual see through (VST) camera) with generative image content generated by an image generation model. In some examples, the computing device is a head-mounted display device (e.g., a headset). The camera system may allow a user to see their real-world surroundings on the device's display. For example, the camera system may capture a live video feed of the real world, which is then displayed on the device's display. The camera system has a field of view that is less than the device's field of view.

The computing device provides a technical solution of using the generative image content for an outer portion (e.g., peripheral portion) of the device's display. In other words, the computing device may use the generative image content to “fill in” content between the display's field of view and the camera's field of view or to extend the field of view to one that is larger than the camera's field of view. In other words, the computing device may use the generative image content to extend the image sensor data captured by the device's camera to a wider field of view. In this manner, the computing device includes one or more technical benefits of obtaining image sensor data with a high angular resolution (e.g., pixels per degree) and using the generative image content to extend the angular range to provide a wider perceived field of view. This wider perceived field of view may provide a more immersive experience. In some examples, the generative image content includes a peripheral portion that extends between the camera's field of view and the display's field of view.

If there is a difference in scope between the camera's field of view and the display's field of view, some conventional approaches may expand the image sensor data to the display's larger field of view. However, these conventional approaches may reduce the angular resolution of the visual data (e.g., spreading the pixels out over a larger area). A computing device having a high resolution camera with a wider field of view may require high sensor power and/or increased computing resources for image signal processing, which can increase the size and cost of devices. However, cameras with a lower field of view may have reduced distortion, higher image quality, and/or higher angular resolution. According to the techniques discussed herein, the computing device uses a camera system with a lower field of view (but with higher angular resolution) and communicates with an image generation model to generate image content (e.g., artificial intelligence (AI) image content) for the portion between the camera's field of view and the display's field of view, e.g., the peripheral portion. According to the techniques discussed herein, the technical benefits may also include reducing the amount of sensor power required by the camera(s) and/or the amount of power used for image signal processing while providing high quality imagery with a larger field of view. As will be appreciated, the image content generated by the image generation model represents a prediction, based on the image sensor data representing the field of view of the camera system, of what is present in the portions of the environment that correspond to the peripheral portions of the display's field of view. This is in some ways similar to how the human brain is thought to handle human peripheral vision in which the brain is thought to “fill in” what is “seen” in our peripheral vision.

The computing device includes a camera system configured to generate image sensor data about real-world objects in the camera's field of view. The field of view of the camera system is less than the field of view of the display of the computing device. In some examples, the image sensor data has a relatively high angular resolution such as a higher pixel density (e.g., pixels per inch (PPI)). In some examples, the angular resolution of the camera system is equal to or greater to the angular resolution of the display of the computing device. In some examples, the camera system is a binocular VST system. For example, the camera system may include a first image sensor configured to capture a first image (e.g., a right image) and a second image sensor configured to capture a second image (e.g., a left image), and the computing device may display a separate image to each eye. In some examples, the camera system is a single view VST system. For example, the camera system may include an image sensor (e.g., a single image sensor) configured to capture an image, and the computing device may create, using the image, separate images for display.

The computing device may include a model interface engine configured to transmit the image sensor data to an image generation model to generate the generative image content. The image generation model may receive the image sensor data as an input, which causes the image generation model to generate the generative image content. In some examples, the input includes a current image frame of the image sensor data. For example, the image generation model may generate generative image content for each image frame of the image sensor data (e.g., on a per-frame basis). In some examples, the input includes the current image frame and one or more previous image frames. In some examples, using one or more previous image frames may cause the image generation model to generate temporally consistent image content (e.g., visually consistent across image frames). In some examples, the input includes three-dimensional (3D) pose information about a position and/or an orientation of the computing device in 3D space. In some examples, the 3D pose information is six degrees of freedom (6DoF) pose information (e.g., x, y, z coordinates and pitch, roll, and yaw angles). In some examples, using the 3D pose information as an input may cause the image generation model to generate spatially consistent images (e.g., visually consistent left and right eye images).

In some examples, the image generation model may be an image-to-image machine-learning model configured to generate image data that extends the camera's field of view using the image sensor data as an input. In other words, the image generation model may generate outer image data that extends the image sensor data so that the combination of the image sensor data and the generative image content provides a field of view that is greater than the camera's field of view with relatively high angular resolution. In other words, the image generation model may generate generative image content to fill-in the difference between the display's field of view and the camera's field of view. In some examples, the image generation model is stored in the computing device. In some examples, the image generation model is stored on one or more server computers, and the computing device may communicate with the image generation model over a network.

The computing device includes an image modification engine that generates display content by combining the image sensor data and the generative image content to provide a larger visual experience with high angular resolution. In some examples, the computing device includes a combiner configured to generate mixed reality content by combining the display content with virtual content, where the mixed reality content is displayed on the device's display.

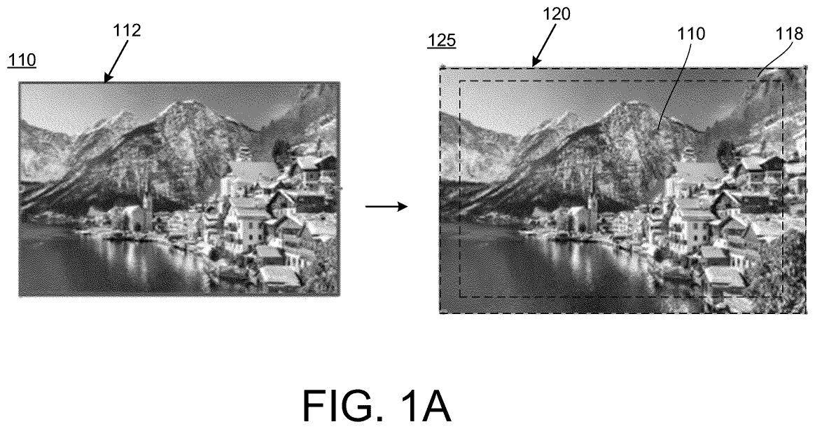

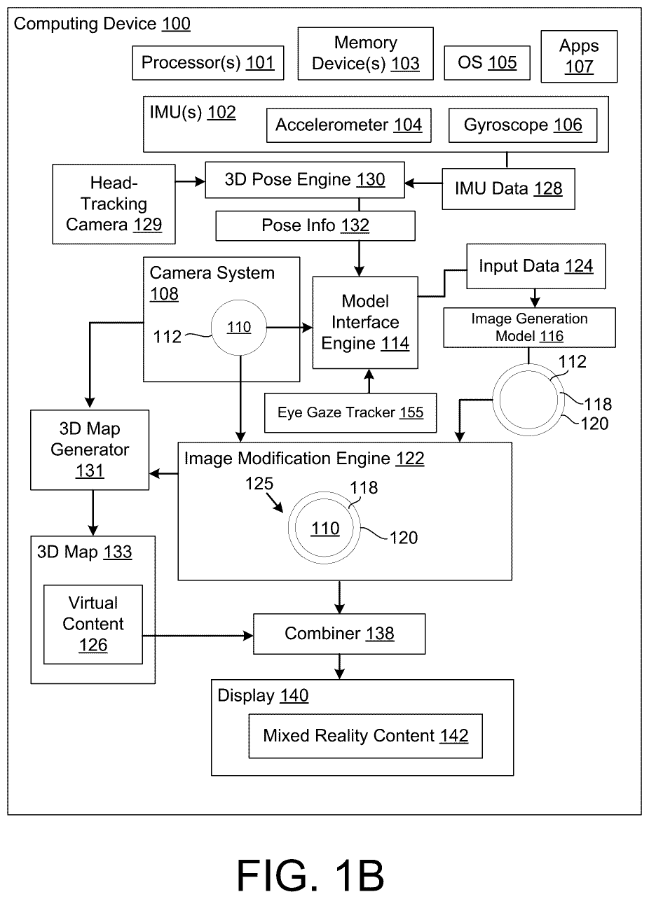

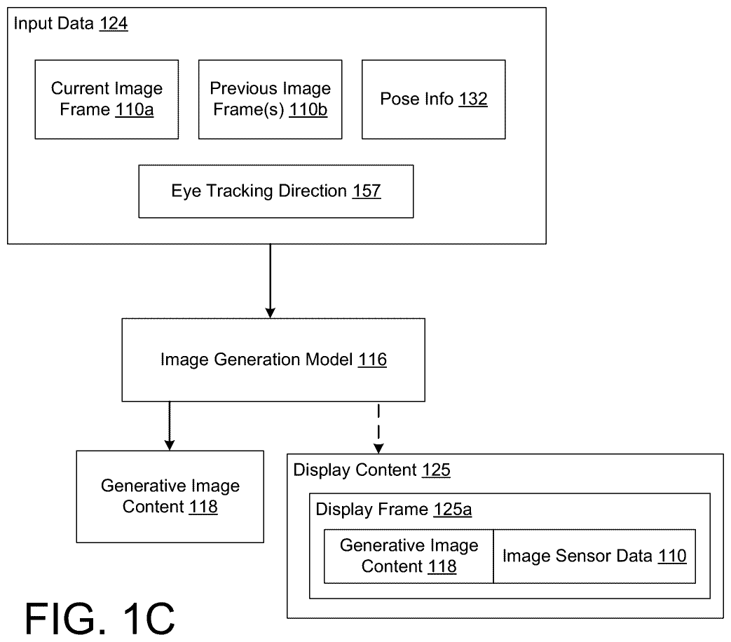

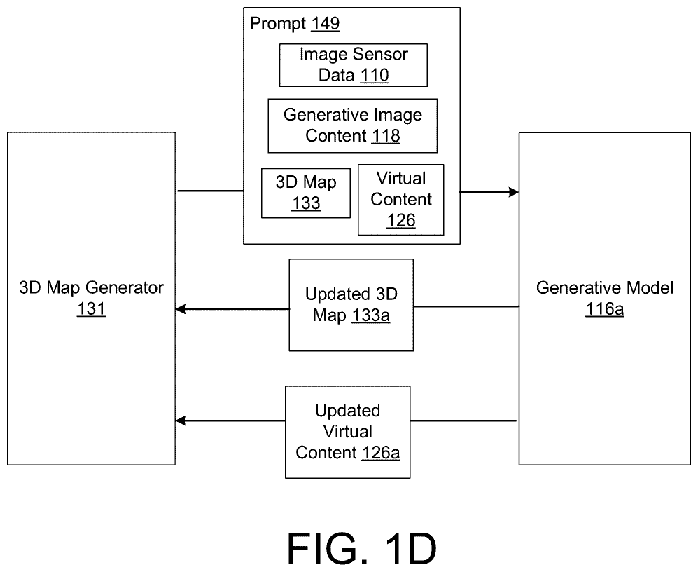

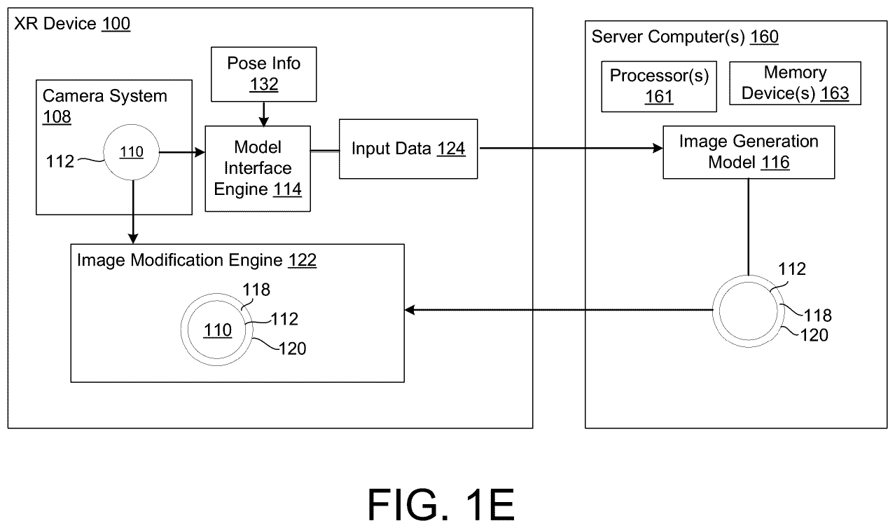

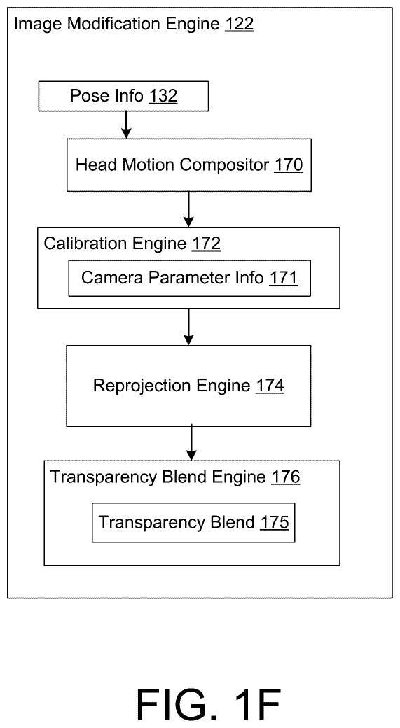

FIGS. 1A to 1F illustrate a computing device 100 configured to generate display content 125 by combining image sensor data 110 from a camera system 108 with generative image content 118 generated by an image generation model 116. In some examples, the computing device 100 is an extended reality device. In some examples, the computing device 100 is a headset. In some examples, the computing device 100 is a smartphone, laptop, other wearable device, or desktop computer. In some examples, the camera system 108 has a field of view 112 that is less than a field of view 120 of a display 140 of the computing device 100. The computing device 100 uses the generative image content 118 for an outer portion (e.g., peripheral portion) of the device's display 140. In this manner, the camera system 108 may obtain image sensor data 110 with a high angular resolution (e.g., pixels per degree) and may use the generative image content 118 for outer visual content to provide a more immersive experience. In some examples, the generative image content 118 includes a peripheral portion that extends between the field of view 112 and the field of view 120.

FIG. 1A illustrates a transformation of the image sensor data 110 with a more limited field of view 112 to an expanded field of view 120 with a combination of the image sensor data 110 and the generative image content 118. For example, the image generation model 116 may receive input data 124, which includes the image sensor data 110, and may generate the generative image content 118 based on the input data 124. The computing device 100 generates display content 125 by combining the image sensor data 110 and the generative image content 118, thereby providing a more immersive experience.

Referring to FIG. 1B, the computing device 100 may be a wearable device. In some examples, the computing device 100 is a head-mounted display device. The computing device 100 may be an augmented reality (AR) device or a virtual reality (VR) device. The computing device 100 may include an optical head-mounted display (OHMD) device, a transparent heads-up display (HUD) device, an augmented reality (AR) device, or other devices such as goggles or headsets having sensors, display, and computing capabilities. In some examples, the computing device 100 is a smartphone, a laptop, a desktop computer, or generally any type of user device. In some examples, the computing device 100 is a user device that can provide a virtual reality or augmented reality experience.

The computing device 100 includes a camera system 108 configured to generate image sensor data 110 with a field of view 112. In some examples, the camera system 108 is a video see-through (VST) or a video pass-through camera system. The camera system 108 may include one or more red-green-blue (RGB) cameras. In some examples, the camera system 108 includes a single camera device. In some examples, the camera system 108 includes multiple camera devices. In some examples, the camera system 108 includes one or more monocular cameras. In some examples, the camera system 108 includes stereo cameras. In some examples, the camera system 108 includes a right eye camera and a left eye camera. The camera system 108 is a type of camera system that allows the user to see the real world through the camera's lens while also seeing virtual content 126 overlaid on the real world. For example, the camera system 108 may allow a user to see their real-world surroundings while wearing a headset or operating a user device. The camera system 108 may capture a live video feed of the real world, which is then displayed on the device's display 140. In some examples, the camera system 108 is referred to as an AR camera, a mixed reality camera, a head-mounted display camera, a transparent display camera, or a combiner camera.

The image sensor data 110 may be referred to as pass-through video. The image sensor data 110 may be referred to as a real-world video feed. In some examples, the image sensor data 110 is not a live video feed. In some examples, the image sensor data 110 does not reflect the user's surroundings but any type of video footage. In some examples, the image sensor data 110 is image data from a storage device or memory on the computing device 100. In some examples, the image sensor data 110 is image that is received from another computing device such as another user device, another camera system, from a server computer, which can be live video or stored video. In some examples, the image sensor data 110 is received or obtained from a single source such as the camera system 108 of the computing device 100, where the camera system 108 may include one or multiple cameras. In some examples, the image sensor data 110 is obtained from multiple sources. For example, the computing device 100 may obtain the image sensor data 110 from the camera system 108 and another computing device (or camera system) that is separate and distinct from the computing device 100.

In some examples, the image sensor data 110 includes a first image (e.g., a right image) and a second image (e.g., a left image) for each frame. In some examples, the camera system 108 is a binocular VST system. For example, the camera system 108 may include a first image sensor configured to capture the first image (e.g., the right image) and a second image sensor configured to capture the second image (e.g., the left image), and, in some examples, the computing device 100 may display a separate image to each eye. In some examples, the image sensor data 110 includes an image (e.g., a single image) for each frame. In some examples, the camera system 108 is a single view VST system. For example, the camera system 108 may include an image sensor (e.g., a single image sensor) configured to capture an image, and the computing device 100 may create, using the image, separate images for display.

The camera's field of view 112 may be the angular extent of the scene that is captured by the camera system 108. The field of view 112 may be measured in degrees and may be specified as a horizontal field of view and/or a vertical field of view. The field of view 112 may be determined by the focal length of the lens and the size of the camera system 108. In some examples, the field of view 112 of the camera system 108 is less than a field of view 120 of a display 140 of the computing device 100. Instead of expanding the image sensor data 110 to the display's larger field of view 120, the computing device 100 may add generative image content 118 to the image sensor data 110 to expand the display content 125.

The computing device 100 includes a model interface engine 114 and is configured to communicate with the image generation model 116 to obtain or receive generative image content 118, which is added to the image sensor data 110 to expand the amount of display content 125 that is displayed on a display 140 of the computing device 100. In some examples, the computing device 100 performs foveated rendering, e.g., prioritizes rendering high-resolution details in the center region of the user's field of view, thereby providing one or more technical benefits of improving performance and/or battery life. In some examples, the computing device 100 uses the image generation model 116 to generate generative image content 118 for a region (e.g., a periphery region) that is outside of the center region of the user's field of view. In some examples, the generative image content 118 also includes high-resolution details. In some examples, the generative image content 118 has a resolution that is the same as the resolution of the foveated region. In some examples, the generative image content 118 has a resolution that is less than the resolution of the foveated region.

The model interface engine 114 is configured to transmit input data 124 to the image generation model 116. In some examples, while the display 140 is displaying display content 125 (e.g., while the live video feed is passed through to the display 140), the model interface engine 114 may continuously transmit the input data 124 to the image generation model 116. The model interface engine 114 receives the image sensor data 110 from the camera system 108 and includes the image sensor data 110 in the input data 124 provided to the image generation model 116. In other words, the model interface engine 114 transfers the image sensor data 110, as the image sensor data 110 is generated by the camera system 108, to the image generation model 116.

In some examples, as shown in FIG. 1C, the input data 124 includes a current image frame 110a of the image sensor data 110. An image frame (e.g., a current image frame 110a or a previous image frame 110b) includes pixel data. The pixel data, for each pixel, includes information about a specific color and intensity value. In some examples, the image sensor data 110 includes metadata such as a timestamp, camera parameter information 171 about one or more camera parameters (e.g., data about the camera's settings such as exposure, ISO, and white balance), lens distortion information about the lens's distortion, and/or camera position and orientation information about the camera's position and orientation in the real world.

In some examples, the current image frame 110a includes the first image (e.g., right image) and the second image (e.g., left image). In some examples, the model interface engine 114 may sequentially transfer each image frame to the image generation model 116. In some examples, the input data 124 includes a current image frame 110a and one or more previous image frames 110b. The previous image frames 110b may be image frames that have been rendered. The current image frame 110a may be an image frame that is currently being rendered. In some examples, the model interface engine 114 stores at least a portion of the image sensor data 110 such as the last X number of image frames. In some examples, the input data 124 includes the current image frame 110a and a previous image frame 110b. The previous image frame 110b may immediately precede the current image frame 110a.

In some examples, the input data 124 includes the current image frame 110a, a first previous image frame 110b, and a second previous image frame 110b. In some examples, the input data 124 includes the current image frame 110a, a first previous image frame 110b, a second previous image frame 110b, and a third previous image frame 110b. In some examples, the use of one or more previous image frames 110b as input may provide one or more technical benefits of generating temporally consistent image frames. Temporally consistent image frames refer to a sequence of frames in a video where there is a smooth and logical progression of objects and events over time (e.g., the video looks natural and fluid, without any jarring jumps or inconsistencies).

In some examples, the input data 124 includes the image sensor data 110 and pose information 132 about an orientation and/or the position of the computing device 100. In some examples, the input data 124 includes the current image frame 110a, one or more previous image frames 110b, and the pose information 132 generated by a 3D pose engine 130. The pose information 132 includes information about a position and/or an orientation of the computing device 100 in 3D space. The position may be the 3D position of one or more keypoints of the computing device 100. In some examples, the pose information 132 is six degrees of freedom (6DoF) pose information (e.g., x, y, z coordinates and pitch, roll, and yaw angles). In some examples, using the pose information 132 as an input may provide one or more technical benefits of generating spatially consistent images (e.g., visually consistent left and right eye images). For example, use of the pose information 132 may allow content to be updated in a spatially and temporally coherent manner. Spatially consistent image frames in a computing device 100 refer to a sequence of images that accurately represent the real-world environment, e.g., that objects in the generative image content 118 appear spatially consistent with objects in the image sensor data 110. In some examples, the input data 124 includes other types of data associated with the user's surrounding such as text data and/or audio data. In some examples, the input data 124 includes sensor data from other sensors on the computing device 100 such as depth information, data from one or more environmental sensors (e.g., barometer, ambient light sensor, a proximity sensor, a temperature sensor), data from one or more user input sensors (e.g., display screen UIs, microphones, speakers, etc.), and/or data from one or more biometric sensors.

The computing device 100 may include an inertial measurement unit (IMU) 102 configured to generate IMU data 128. The IMU 102 is a device that measures orientation and/or motion of the computing device 100. The IMU 102 may include an accelerometer 104 and a gyroscope 106. The accelerometer 104 may measure acceleration of the computing device 100. The gyroscope 106 may measure angular velocity. The IMU data 128 may include information about the orientation, acceleration and/or angular velocity of the computing device 100. The computing device 100 may include a head-tracking camera 129 configured to track movements of a user's head. In some examples, the head-tracking camera 129 may use infrared (IR) light to track the position of the user's head. The 3D pose engine 130 may receive the IMU data 128 and the output of the head-tracking camera 129 and generate pose information 132 about a 3D pose of the computing device 100. In some examples, the pose information 132 is the 6DoF pose, e.g., the translation on X-axis, Y-axis, and Z-axis, and the rotation around the X-axis, Y-axis, and the Z-axis.

In some examples, the computing device 100 includes an eye gaze tracker 155 configured to compute an eye tracking direction 157, e.g., a direction (e.g., a point in space) where the user's gaze is directed. The eye gaze tracker 155 may process the raw data captured by the device's eye-tracking sensors to extract meaningful information about the user's gaze. This information can then be used to enhance the user's experience in various ways. The eye gaze tracker 155 receives raw data from the eye-tracking sensors (e.g., near-infrared cameras and light sources), processes the raw data to identify and track the user's pupils and corneal reflections, and calculates the eye tracking direction 157, e.g., the point in space where the user's gaze is directed. In some examples, the eye gaze tracker 155 can also detect the user's eye state, such as whether their eyes are open or closed, and whether they are blinking. In some examples, the eye gaze tracker 155 can measure the size of the user's pupils, which can provide insights into their cognitive load and emotional state.

By tracking the user's gaze, in some examples, the computing device 100 can render high-resolution details in a foveated region (e.g., the area of focus), thereby providing one or more technical benefits of improving performance and/or battery life. In some examples, the computing device 100 may use the image generation model 116 to generate a peripheral portion that surrounds the foveated region. In some examples, the input data 124 includes a user's calculated eye gaze. The image generation model 116 may use the user's calculated eye gaze to generate generative image content 118 for at least a portion of a region outside of the foveated region.

Based on the input data 124, the image generation model 116 generates generative image content 118. In some examples, the image generation model 116 uses the image sensor data 110 of a current image frame to generate generative image content 118 for the current image frame. In some examples, the generative image content 118 for a current image frame includes a right eye portion (e.g., peripheral portion) for the right image, and a left eye portion (e.g., peripheral portion) for the left image. In some examples, the image generation model 116 uses the image sensor data 110 of a current image frame 110a and the image sensor data 110 of one or more previous image frames 110b to generate generative image content 118 for the current image frame 110a. In some examples, using one or more previous image frames 110b may provide one or more technical benefits of generating temporally consistent image content (e.g., visually consistent across image frames).

In some examples, the image generation model 116 also uses the pose information 132 associated with the current image frame 110a (and, in some examples, the pose information 132 associated with one or more previous image frames 110b) to assist with generating the generative image content 118 for the current image frame 110a. In some examples, using the pose information 132 within the input data 124 may provide one or more technical benefits of generating spatially consistent images (e.g., visually consistent left and right eye images). In some examples, the image generation model 116 may generate generative image content 118 for the right image or the left image, and the image generation model 116 (or the image modification engine 122) may use the generative image content 118 for the right image or the left image to generate content for at least a portion of the other image (e.g., re-projecting generative image content 118 from the perspective of the other eye).

The generative image content 118 may be image data between the display's field of view 120 and the camera's field of view 112. In some examples, the generative image content 118 includes a peripheral portion that surrounds the image sensor data 110 from the camera system 108. In some examples, the generative image content 118 includes an annulus of visual content that surrounds the image sensor data 110. In some examples, the generative image content 118 includes an outer ring of image data. In some examples, the generative image content 118 includes a border region that surrounds the image sensor data 110. The generative image content 118 may extend the image sensor data 110 so that visual content extends beyond the field of view 112. The generative image content 118 is added to the image sensor data 110 to expand the display content 125. In some examples, the generative image content 118 and the image sensor data 110 may represent different (separate) portions of the physical environment. In some examples, the generative image content 118 has a portion that overlaps with a portion of the image sensor data 110.

An image generation model 116 is a type of machine learning model that can create generative image content 118 for other portion(s) of a scene based on image sensor data 110, and, in some examples, other types of input data 124 described herein. In some examples, the image generation model 116 is an image-to-image machine-learning model (e.g., a neural network based model). In some examples, the image generation model 116 includes one or more generative adversarial networks (GANs). In some examples, the image generation model 116 includes one or more variational autoencoders (VAEs). In some examples, the image generation model 116 includes one or more diffusion models. In some examples, the image generation model 116 is a multi-modality generative model that can receive image, audio, and/or text data, and generate image audio, and/or text data.

The image generation model 116 may receive image sensor data 110 as an input and generate an outer peripheral portion that extends the image sensor data 110. In some examples, the image generation model 116 may receive other types of data such as text and/or sound, and may generate content that enhances and/or expands the image data including text and/or sound data. In some examples, the image generation model 116 may be trained using a collection of images, where a sub-portion (e.g., the central region of the images) are used to train the image generation model 116 to predict (generate) an outer peripheral portion of the images. In some examples, the image generation model 116 is calibrated (e.g., trained) to create generative image content 118 for the computing device 100. In some examples, the image generation model 116 obtains the field of view 120, the resolution, and/or the orientation of the display 140 and obtains the field of view 112, the resolution, and the orientation of the camera system 108. In some examples, during a calibration process, the void in coverage between the camera's FOV (e.g., field of view 112) and the display's FOV (e.g., field of view 120) is evaluated. In some examples, the image generation model 116 may receive audio data captured from one or more microphones on the computing device, and may generate audio data that enhances the sound in the environment, suppresses noise, and/or removes one or more sound artifacts.

As shown in FIG. 1B, the image generation model 116 is stored on the computing device 100. In some examples, the image generation model 116 has a number of parameters (e.g., model weights and configuration files) that is less than a threshold number, and the image generation model 116 may be capable of being stored on a memory device 103 of the computing device 100. In some examples, as shown in FIG. 1E, the image generation model 116 is stored on one or more server computers 160. For example, the computing device 100 may communicate with an image generation model 116 over a network. For example, the computing device 100 may transmit, over the network, the input data 124 to the image generation model 116 and may receive, over the network, generative image content 118 from the image generation model 116.

Referring to FIG. 1B, the computing device 100 includes an image modification engine 122 that receives the image sensor data 110 from the camera system 108 and the generative image content 118 from the image generation model 116. The image modification engine 122 generates display content 125 by combining the image sensor data 110 and the generative image content 118. The image modification engine 122 combines the image sensor data 110 and the generative image content 118 for a current image frame to be displayed on the display 140. The image modification engine 122 combines the image sensor data 110 and the generative image content 118 for each image frame that is displayed on the display 140. In some examples, combining the image sensor data 110 and the generative image content 118 include aligning the generative image content 118 with the image sensor data 110. In some examples, the image generation model 116 is configured to combine the image sensor data 110 and the generative image content 118, and the image modification engine 122 receives the combined content, e.g., the display content 125.

In some examples, the image modification engine 122 or the image generation model 116 may align the generative image content 118 with the image sensor data 110 by performing feature detection and matching. For example, the image modification engine 122 or the image generation model 116 may identify distinctive features (e.g., corners, edges, or texture patterns) in the generative image content 118 and the image sensor data 110. The image modification engine 122 or the image generation model 116 may match corresponding features between the images (e.g., using scale-invariant feature transform (SIFT) or speeded up robust features (SURF)). In some examples, the image modification engine 122 or the image generation model 116 may align the generative image content 118 with the image sensor data 110 by performing geometric transformation estimation. In some examples, the image modification engine 122 or the image generation model 116 may calculate a homography matrix, which represents the geometric transformation (e.g., rotation, translation, and scaling) required to map one image onto the other. The image modification engine 122 or the image generation model 116 may use affine or perspective transformation to align the generative image content 118 and the image sensor data 110. In some examples, the image modification engine 122 or the image generation model 116 may align the generative image content 118 with the image sensor data 110 by performing image wrapping. For example, the image modification engine 122 or the image generation model 116 may apply a calculated geometric transformation to one of the images to align it with the other, which may involve resampling pixels and interpolating values.

The image modification engine 122 may store one or more X numbers of display frames 125a in the memory device 103, where X can be any integer greater or equal to two. The display frames 125a may be image frames that are rendered on the display 140. In some examples, a current image frame 110a or a previous image frame 110b may be used instead of a display frame 125a. A display frame 125a includes the image sensor data 110 from a current image frame 110a and the generative image content 118. In some examples, the image modification engine 122 may store the display frames 125a for a threshold period of time, e.g., five, ten, fifteen seconds, etc. A display frame 125a includes the image sensor data 110 and the generative image content 118. In some examples, the image modification engine 122 may store a display frame 125a along with the pose information 132, and, in some examples, the eye tracking direction 157 from the eye gaze tracker 155. The computing device 100 initiates display of the display content 125 on the display 140, where the display content 125 includes the image sensor data 110 and the generative image content 118.

Referring back to FIG. 1B, in some examples, the computing device 100 includes a combiner 138 that generates mixed reality content 142 by combining the display content 125 and virtual content 126. The virtual content 126 may be one or more virtual objects that are overlaid on the display content 125. In some examples, the virtual content 126 may be a virtual object added by a user of the computing device 100, another computing device, or an application 107 executing on the computing device 100. Overlaying of the virtual content 126 may be implemented, for example, by superimposing the VR content 126 into an optical field of view of a user of the physical space, by reproducing a view of the physical space on the display 140. Reproducing a view of the physical space includes rendering the display content 125 on the display 140. In some examples, the combiner 138 includes a waveguide combiner. In some examples, the combiner 138 includes a beamsplitter combiner.

In some examples, the computing device 100 includes a three-dimensional (3D) map generator 131 that generates a 3D map 133 based on the image sensor data 110 and the pose information 132. In some examples, the 3D map generator 131 generates a set of feature points with depth information in space from the image sensor data 110 and/or the pose information 132 and generates the 3D map 133 using the set of feature points. The set of feature points are a plurality of points (e.g., interesting points) that represent the user's environment. In some examples, each feature point is an approximation of a fixed location and orientation in the physical space, and the set of visual feature points may be updated over time.

In some examples, the set of feature points may be referred to as an anchor or a set of persistent visual features that represent physical objects in the physical world. In some examples, the virtual content 126 is attached to one or more feature points. For example, the user of the computing device 100 can place a napping kitten on the corner of a coffee table or annotate a painting with biographical information about the artist. Motion tracking means that a user can move around and view these virtual objects from any angle, and even if you turn around and leave the room, when you come back, the virtual content 126 will be right where the user left it.

The 3D map 133 includes a model that represents the physical space of the computing device 100. In some examples, the 3D map 131 includes a 3D coordinate space in which visual information (e.g., image sensor data 110, generative image content 118) from the physical space and virtual content 126 are positioned. In some examples, the 3D map 131 is a sparse point map or a 3D point cloud. In some examples, the 3D map 131 is referred to as a feature point map or a worldspace. A user, another person, or an application 107 can add virtual content 126 to the 3D map 131 to position virtual content 126. For example, virtual content 126 can be positioned in the 3D coordinate space. The computing device 100 may track the user's position and orientation within the worldspace (e.g., the 3D map 133), ensuring that virtual content 126 appears in the correct position relative to the user.

In some examples, the 3D map 133 is used to share an XR environment with one or more users that join the XR environment and to calculate where each user's computing device 100 is located in relation to the physical space of the XR environment such that multiple users can view and interact with the XR environment. The 3D map 133 may be used to localize the XR environment for a secondary user or localize the XR environment for the computing device 100 in a subsequent session For example, the 3D map 133 (e.g., worldspace) may be used to compare and match against image sensor data 110 captured by a secondary computing device in order to determine whether the physical space is the same as the physical space of the stored 3D map 133 and to calculate the location of the secondary computing device within the XR environment in relation to the stored 3D map 133.

Virtual content 126 may be computer-generated graphics that are overlaid on the display content 125. The virtual content 126 may be 2D or 3D objects. In some examples, the virtual content 126 may be referred to as a virtual object model that represents a 3D object.

A virtual object model may include information about the geometry, topology, and appearance of a 3D object. The 3D object model may define the shape and structure of the 3D object, and may include information about vertices, edges, and/or faces that form the object's surfaces. The 3D object model may include information about the connectivity and relationships between the geometric elements of the model, and may define how the vertices, edges, and faces are connected to form the object's structure. The 3D object model may include texture coordinates that define how textures or images are mapped into the surfaces of the model and may provide a correspondence between the points on the 3D surface and the pixels in a 2D texture image. In some examples, the 3D object model may include information about normals (e.g., vectors perpendicular to the surface at each vertex or face) that determine the orientation and direction of the surfaces, indicating how light interacts with the surface during shading calculating. The 3D object model may include information about material properties that describe the visual appearance and characteristics of the 3D object's surfaces, and may include information such as color, reflectivity, transparency, shininess, and other parameters that affect how the surface interacts with light. In some examples, the 3D object model is configured as a static model. In some examples, the 3D object model is configured as a dynamic model (also referred to as an animated object) that includes one or more animations. An animated object may be referred to as an animated mesh or animated rig.

In some examples, as shown in FIG. 1D, the 3D map generator 131 may communicate with a generative model 116a to generate an updated 3D map 133a and/or updated virtual content 126a. In some examples, the generative model 116a is the same model as the image generation model 116. In some examples, the generative model 116a is a generative model that is different from (or separate to) the image generation model 116. In some examples, the generative model 116a may update the 3D map 133a based on the image sensor data 110, the generative image content 118. In some examples, the 3D map generator 131 may generate a prompt 149, where the prompt 149 includes the image sensor data 110, the generative image content 118, the 3D map 133, and the virtual content 126. In response to the prompt 149, the generative model 116a may generate an updated 3D map 133a that enhances the 3D map 133 with the generative image content 118. The updated 3D map 133a may have enhanced properties in terms of scale, light, scene dependency, or other properties related to 3D scene generation.

In some examples, the 3D map generator 131 may communicate with the generative model 116a to generate updated virtual content 126a that better conforms to the physical scene. In some examples, the 3D map generator 131 may generate a prompt 149, where the prompt 149 includes the image sensor data 110, the generative image content 118, and/or the virtual content 126. In response to the prompt 149, the generative model 116a may generate an updated virtual content 126a. The updated virtual content 126 may include one or more changes to the geometry, topology, and/or appearance of a 3D object that better conforms to the physical scene.

Referring to FIG. 1F, the image modification engine 122 may perform one or more operations for processing and/or combining the display content 125. The image modification engine 122 may include a head motion compositor 170 configured to generate display content 125 for a current image frame 110a based on the pose information 132 and the generative image content 118 for a previous image frame 110b. From the pose information 132, the head motion compositor 170 may determine that the current head position corresponds to a previous head position for which generative image content 118 has been already generated for the current image frame 110a. Instead of generating new generative image content 118, the head motion compositor 170 may re-use the generative image content 118 for a previous image frame 110b, where the previous image frame 110b corresponds to the current head position as indicated by the pose information 132.

For example, the head motion compositor 170 may receive generative image content 118 from one or more previous images frames 110b (e.g., previously generated generative image content 118) for one or more portions of the generative image content 118 for a current image frame 110a. In some examples, the image modification engine 122 may obtain the generative image content 118 for one or more previous image frames 110b from the memory device 103. In some examples, if the pose information 132 for a current image frame 110a corresponds to the pose information 132 for a previous image frame 110b, the head motion compositor 170 may obtain the generative image content 118 for the previous image frame 110b. In some examples, the image modification engine 122 may receive information from the opposite side's camera to ensure binocular consistency in a binocular overlap region (e.g., an overlapping portion between the right image and the left image). As the user moves their head around, the image generation model 116 may have already generated generative image content 118 for a current image frame 110a. In some examples, the head motion compositor 170 may composite at least a portion of the generative image content 118 for a current image frame 110a using the generative image content 118 for one or more previous image frames 110b.

In some examples, the image modification engine 122 may include a calibration engine 172 configured to calibrate the generative image content 118 and the image sensor data 110 using camera parameter information 171 about one or more camera parameters to account for distortion and/or warping. In some examples, the calibration engine 172 may obtain the camera parameter information 171 from the memory device 103. In some examples, the calibration engine 172 may obtain the camera parameter information 171 from the image sensor data 110. The calibration engine 172 may adjust the image sensor data 110 and/or the generative image content 118 using the camera parameter information 171 about the camera parameters. In some examples, the camera parameters may include intrinsic camera parameters. The intrinsic camera parameters may include physical properties of the camera, such as the focal length, principal point, and/or skew. In some examples, the camera parameters include extrinsic camera parameters. In some examples, the extrinsic camera parameters include the pose information 132 (e.g., the 6DoF parameters such as the x, y, z locations, and pitch, yaw, and roll).

The image modification engine 122 may include a reprojection engine 174 configured to reproject the image sensor data 110 and the generative image content 118 based on head movement. For example, there may be latency from when a current image frame 110a is captured and when the current image frame 110a is rendered. In some examples, there may be head movement between the time of when the current image frame 110a is captured and when the current image frame 110a is to be rendered. The reprojection engine 174 may reproject the image sensor data 110 and the generative image content 118 when head movement occurs between the time of when the current image frame 110a is captured and when the current image frame 110a is to be rendered. In some examples, the reprojection engine 174 includes a neural network configured to execute a temporal-based inference using one or more previously rendered image frames (e.g., previously rendered display frames 125a) and the current display frame 125a to be rendered. In some examples, the image generation model 116 generates the generative image content 118 based on the current image frame 110a. Then, the reprojection engine 174 may re-generate the generative image content 118 using one or more previous image frames 110b to ensure temporal consistency.

The image modification engine 122 may include a transparency blend engine 176, which applies a transparency blend 175 to the image sensor data 110 and the generative image content 118. Application of the transparency blend 175 may bend the pixels at the border region or the intersection of the image sensor data 110 and the generative image content 118. Bending a pixel may include adjusting a pixel value to have a value between a pixel value of the image sensor data 110 and a pixel value of the generative image content 118. In some examples, the transparency blend 175 is referred to as an alpha blend. Alpha blending is a technique used to combine two or more images based on their alpha values. The alpha value may be a number between zero and one that represents the transparency or a color of a pixel. A pixel with an alpha value of zero is completely transparent, while a pixel with an alpha value of one is completely opaque. In some examples, the transparency blend engine 176 may compute a color of the pixel by multiplying the color values of the generative image content 118 and the image sensor data 110 by their respective alpha values, and then summing the results.

The computing device 100 may include one or more processors 101, one or more memory devices 103, and an operating system 105 configured to execute one or more applications 107. The processor(s) 101 may be formed in a substrate configured to execute one or more machine executable instructions or pieces of software, firmware, or a combination thereof. The processor(s) 101 can be semiconductor-based—that is, the processors can include semiconductor material that can perform digital logic. The memory device(s) 103 may include any type of storage device that stores information in a format that can be read and/or executed by the processor(s) 101. In some examples, the memory device(s) 103 is/are a non-transitory computer-readable medium. In some examples, the memory device(s) 103 includes a non-transitory computer-readable medium that includes executable instructions that cause at least one processor (e.g., the processor(s) 161) to execute operations discussed with reference to the computing device 100. The applications 107 may be any type of computer program that can be executed by the computing device 100, including native applications that are installed on the operating system 105 by the user and/or system applications that are pre-installed on the operating system 105.

The server computer(s) 160 may be computing devices that take the form of a number of different devices, for example a standard server, a group of such servers, or a rack server system. In some examples, the server computer(s) 160 is a single system sharing components such as processors and memories. In some examples, the server computer(s) 160 stores the image generation model 116. The network may include the Internet and/or other types of data networks, such as a local area network (LAN), a wide area network (WAN), a cellular network, satellite network, or other types of data networks. The network may also include any number of computing devices (e.g., computers, servers, routers, network switches, etc.) that are configured to receive and/or transmit data within the network.

The server computer(s) 160 may include one or more processors 161 formed in a substrate, an operating system (not shown) and one or more memory devices 163. The memory device(s) 163 may represent any kind of (or multiple kinds of) memory (e.g., RAM, flash, cache, disk, tape, etc.). In some examples (not shown), the memory devices may include external storage, e.g., memory physically remote from but accessible by the server computer(s) 160. The processor(s) 161 may be formed in a substrate configured to execute one or more machine executable instructions or pieces of software, firmware, or a combination thereof. The processor(s) 161 can be semiconductor-based—that is, the processors can include semiconductor material that can perform digital logic. The memory device(s) 163 may store information in a format that can be read and/or executed by the processor(s) 161. In some examples, the memory device(s) 163 includes a non-transitory computer-readable medium that includes executable instructions that cause at least one processor (e.g., the processor(s) 161) to execute operations discussed with reference to the image generation model 116.

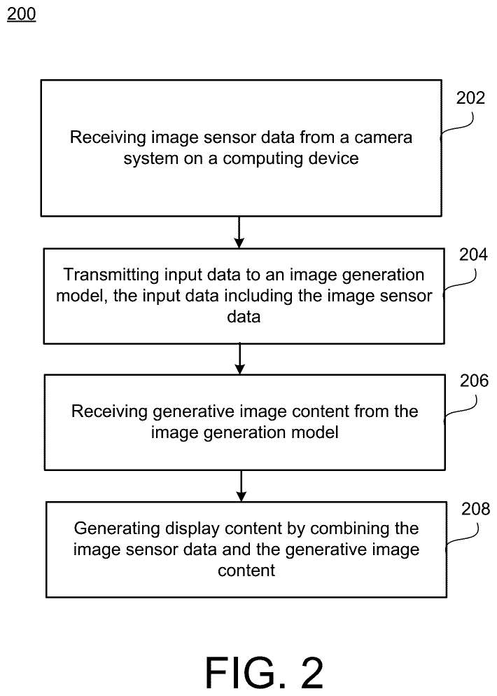

FIG. 2 is a flowchart 200 depicting example operations of a computing device according to an aspect. The example operations enable high angular resolution image content in the display's field of view that is larger than the camera's field of view by combining image sensor data generated by the device's camera with generative image content generated by an image generation model. The computing device includes a camera system configured to generate image sensor data about real-world objects in the device's field of view. The camera system has a field of view that is less than the device's field of view. In some examples, the image sensor data has a relatively high angular resolution. In some examples, the angular resolution of the image sensor data is equal to or greater to the pixels per degree of the display of the computing device.

The flowchart 200 may depict operations of a computer-implemented method. Although the flowchart 200 is explained with respect to the computing device 100 of FIGS. 1A to 1F, the flowchart 200 may be applicable to any of the implementations discussed herein. Although the flowchart 200 of FIG. 2 illustrates the operations in sequential order, it will be appreciated that this is merely an example, and that additional or alternative operations may be included. Further, operations of FIG. 2 and related operations may be executed in a different order than that shown, or in a parallel or overlapping fashion. The flowchart 200 may depict a computer-implemented method.

Operation 202 includes receiving image sensor data from a camera system on a computing device. Operation 204 includes transmitting input data to an image generation model, the input data including the image sensor data. Operation 206 includes receiving generative image content from the image generation model. Operation 208 includes generating display content by combining the image sensor data and the generative image content.

Clause 1. A computing device comprising: at least one processor; and a non-transitory computer readable medium storing executable instructions that cause the at least one processor to execute operations, the operations comprising: receiving image sensor data from a camera system on a computing device; transmitting input data to an image generation model, the input data including the image sensor data; receiving generative image content from the image generation model; and generating display content by combining the image sensor data and the generative image content.

Clause 2. The computing device of clause 1, wherein the camera system has a first field of view that is less than a second field of view of a display of the computing device.

Clause 3. The computing device of clause 2, wherein the generative image content includes a peripheral portion between the first field of view and the second field of view.

Clause 4. The computing device of clause 1, wherein the input data includes a current image frame.

Clause 5. The computing device of clause 1, wherein the input data includes a current image frame and one or more previous image frames.

Clause 6. The computing device of clause 1, wherein the input data includes pose information about an orientation of the computing device.

Clause 7. The computing device of clause 1, wherein the operations further comprise: applying a transparency blend to the image sensor data and the generative image content.

Clause 8. The computing device of clause 1, wherein the operations further comprise: receiving camera parameter information about one or more camera parameters of the camera system; and adjusting at least one of the image sensor data or the generative image content based on the camera parameter information.

Clause 9. The computing device of clause 1, wherein the image generation model is stored locally on the computing device, wherein the operations further comprise: generating, by the image generation model, the generative image content based on the input data.

Clause 10. The computing device of clause 1, wherein the operations further comprise: transmitting, over a network, the input data to the image generation model; and receiving, over the network, generative image sensor data from the image generation model.

Clause 11. A method comprising: receiving image sensor data from a camera system on a computing device; transmitting input data to an image generation model, the input data including the image sensor data; receiving generative image content from the image generation model; and generating display content by combining the image sensor data and the generative image content.

Clause 12. The method of clause 11, wherein the camera system has a first field of view that is less than a second field of view of a display of the computing device, wherein the generative image content includes a peripheral portion between the first field of view and the second field of view.

Clause 13. The method of clause 11, wherein the input data includes a current image frame, one or more previous image frames, and pose information about an orientation of the computing device.

Clause 14. The method of clause 11, further comprising: applying a transparency blend to the image sensor data and the generative image content.

Clause 15. The method of clause 11, further comprising: generating a first image view with the image sensor data and the generative image content; and generating a second image view by re-projecting the first image view.

Clause 16. A non-transitory computer-readable medium storing executable instructions that cause at least one processor to execute operations, the operations comprising: receiving image sensor data from a camera system on a computing device; transmitting input data to an image generation model, the input data including the image sensor data; receiving generative image content from the image generation model; and generating display content by combining the image sensor data and the generative image content.

Clause 17. The non-transitory computer-readable medium of clause 16, wherein the camera system has a first field of view that is less than a second field of view of a display of the computing device.

Clause 18. The non-transitory computer-readable medium of clause 17, wherein the generative image content includes a peripheral portion between the first field of view and the second field of view.

Clause 19. The non-transitory computer-readable medium of clause 16, wherein the input data includes a current image frame, one or more previous image frames, and pose information about an orientation of the computing device.

Clause 20. The non-transitory computer-readable medium of clause 16, wherein the operations further comprise: generating a first image view with the image sensor data and the generative image content; and generating a second image view by re-projecting the first image view.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a uOLED (micro Organic Light Emitting Diode), CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art. Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A computing device comprising:
at least one processor; and
a non-transitory computer readable medium storing executable instructions that cause the at least one processor to execute operations, the operations comprising:
receiving image sensor data from a camera system on a computing device;
transmitting input data to an image generation model, the input data including the image sensor data;
receiving generative image content from the image generation model; and
generating display content by combining the image sensor data and the generative image content.

2. The computing device of claim 1, wherein the camera system has a first field of view that is less than a second field of view of a display of the computing device.

3. The computing device of claim 2, wherein the generative image content includes a peripheral portion between the first field of view and the second field of view.

4. The computing device of claim 1, wherein the input data includes a current image frame.

5. The computing device of claim 1, wherein the input data includes a current image frame and one or more previous image frames.

6. The computing device of claim 1, wherein the input data includes pose information about an orientation of the computing device.

7. The computing device of claim 1, wherein the operations further comprise:
applying a transparency blend to the image sensor data and the generative image content.

8. The computing device of claim 1, wherein the operations further comprise:
receiving camera parameter information about one or more camera parameters of the camera system; and
adjusting at least one of the image sensor data or the generative image content based on the camera parameter information.

9. The computing device of claim 1, wherein the image generation model is stored locally on the computing device, wherein the operations further comprise:
generating, by the image generation model, the generative image content based on the input data.

10. The computing device of claim 1, wherein the operations further comprise:
transmitting, over a network, the input data to the image generation model; and
receiving, over the network, generative image sensor data from the image generation model.

11. A method comprising:
receiving image sensor data from a camera system on a computing device;
transmitting input data to an image generation model, the input data including the image sensor data;
receiving generative image content from the image generation model; and
generating display content by combining the image sensor data and the generative image content.

12. The method of claim 11, wherein the camera system has a first field of view that is less than a second field of view of a display of the computing device, wherein the generative image content includes a peripheral portion between the first field of view and the second field of view.

13. The method of claim 11, wherein the input data includes a current image frame, one or more previous image frames, and pose information about an orientation of the computing device.

14. The method of claim 11, further comprising:
applying a transparency blend to the image sensor data and the generative image content.

15. The method of claim 11, further comprising:
generating a first image view with the image sensor data and the generative image content; and
generating a second image view by re-projecting the first image view.

16. A non-transitory computer-readable medium storing executable instructions that cause at least one processor to execute operations, the operations comprising:
receiving image sensor data from a camera system on a computing device;
transmitting input data to an image generation model, the input data including the image sensor data;
receiving generative image content from the image generation model; and
generating display content by combining the image sensor data and the generative image content.

17. The non-transitory computer-readable medium of claim 16, wherein the camera system has a first field of view that is less than a second field of view of a display of the computing device.

18. The non-transitory computer-readable medium of claim 17, wherein the generative image content includes a peripheral portion between the first field of view and the second field of view.

19. The non-transitory computer-readable medium of claim 16, wherein the input data includes a current image frame, one or more previous image frames, and pose information about an orientation of the computing device.

20. The non-transitory computer-readable medium of claim 16, wherein the operations further comprise:
generating a first image view with the image sensor data and the generative image content; and
generating a second image view by re-projecting the first image view.
